(19) United States
(12) Patent Application Publication
(10) Pub. No.: US 2026/0219223 A1
(43) Pub. Date: Jul. 30, 2026

(54) METAL-OXIDE SEMICONDUCTOR GAS SENSOR

(71) Applicant: TEXAS INSTRUMENTS INCORPORATED, DALLAS, TX (US)

(72) Inventors: Enis TUNCER, DALLAS, TX (US); Rongwei ZHANG, PLANO, TX (US)

(21) Appl. No.: 19/039,285

(22) Filed: Jan. 28, 2025

(51) Int. Cl. G01N 27/12

(52) U.S. Cl. CPC G01N 27/123; G01N 27/125

(57) ABSTRACT

A method includes combining a solution of tin(IV) chloride with a processing solvent to form a mixed solution and performing a first mixing process to the mixed solution for a first predetermined time period at a first predetermined temperature. A hydrolysis process is performed to add water to the mixed solution and a second mixing process is performed to the mixed solution for a second predetermined time period at a second predetermined temperature. A concentration process is performed to the mixed solution to remove the processing solvent and a calcination process is performed to the mixed solution to remove the water from the mixed solution thereby converting the mixed solution from a gel to a solid.

### TECHNICAL FIELD

The present disclosure relates to electronic devices, and more specifically to a metal-oxide semiconductor gas sensor.

### BACKGROUND

Metal-oxide semiconductor sensors are widely utilized to detect environmental gases such as carbon monoxide and nitrogen dioxide. More specifically, metal-oxide sensors have numerous applications such as environmental monitoring, fire detection, detection of harmful gases in mines, home safety, traffic safety, healthcare, etc. The sensitivity of the metal-oxide semiconductor gas sensor is determined by the sensor material and the porosity of the sensor material. Simply put, the sensor material of the metal-oxide semiconductor sensor is heated during operation. When the sensor material encounters a target gas, the electrical resistance of the sensor material changes depending on the oxygen content on its surface. Depending on the type of target gas encountered by the sensor material, the electrical resistance of the sensor material will either increase or decrease.

### SUMMARY

In a described example, a method includes combining a solution of tin(IV) chloride with a processing solvent to form a mixed solution and performing a first mixing process to the mixed solution for a first predetermined time period at a first predetermined temperature. A hydrolysis process is performed to add water to the mixed solution and a second mixing process is performed to the mixed solution for a second predetermined time period at a second predetermined temperature. A concentration process is performed to the mixed solution to remove the processing solvent and a calcination process is performed to the mixed solution to remove the water from the mixed solution thereby converting the mixed solution from a gel to a solid.

In another described example, a gas sensor includes a sensor material configured to detect a target gas, where the sensor material has a nanoporous structure with pores in a range of approximately 10 nanometers to 200. A heating element is configured to provide heat to the sensor material. An electrode is configured to detect a change in resistance through the sensor material upon detection of the target gas.

In still another described example, a metal-oxide semiconductor gas sensor includes a sensor material disposed on a substrate, where the sensor material has a nanoporous structure with pores in a range of approximately 10 nanometers to 200 nanometers and is configured to detect a target gas. A heating circuit is configured to provide a first current through the material and a sensing circuit is configured to detect a second current through the sensor material.

### BRIEF DESCRIPTION OF THE DRAWINGS

FIG. 1 is a cross-sectional view of an example metal-oxide semiconductor sensor.

FIG. 2 is a block diagram flow chart explaining a example process of producing a sensor material for the metal-oxide semiconductor sensor of FIG. 1.

FIG. 3 a microscopic view of the sensor material illustrating nanopores and nanoparticles.

FIG. 4 is an example schematic illustration of an example metal-oxide semiconductor sensor.

FIGS. 5A and 5B are graphs illustrating a sensitivity of an example metal-oxide semiconductor sensor.

### DETAILED DESCRIPTION

Metal-oxide semiconductor sensors are widely utilized to detect environmental gases such as carbon monoxide and nitrogen dioxide. More specifically, metal-oxide sensors have numerous applications such as environmental monitoring, fire detection, detection of harmful gases in mines, home safety, traffic safety, healthcare, etc. The performance of a metal-oxide semiconductor sensor is defined by several parameters including, but not limited to, sensitivity, stability, selectivity, and response and recovery time. Thus, an ideal gas sensor should have high sensitivity and selectivity, good stability, and fast response and recovery times.

Sensitivity is defined as the ability to sense a target gas. The sensitivity of the metal-oxide semiconductor gas sensor is determined by the sensor material and the porosity (e.g., nanoporosity and micro-porosity) of the sensor material. A highly porous sensor material increases the surface area of the sensor material, which increases the sensitivity. A slope of a response curve is used to determine the sensitivity. One method to measure the slope is a change in current through the sensor material from a time when no gas is detected to a time when the target gas is detected. A steeper slope indicates high sensitivity, while a moderate slope signifies a lower sensitivity.

Selectivity is the ability to sense the target gas in the presence of other gases. An ideal gas sensor has high selectivity indicating that it mainly senses the target gas while neglecting other interfering gases. Hence, high selectivity confirms that the sensor provides accurate information about the existence and concentration of gases. Stability is the ability of a sensor to produce reliable results over a period of time. Metal-oxide semiconductor sensors that have a low stability leads to undesired result or false alarms. The response time is the time taken by the metal-oxide semiconductor sensor to reach 90% of the saturation value after the sensor triggers (i.e., detection of the target gas) to an “on” state is the response time. The recovery time is the time taken by the metal-oxide semiconductor sensor to reach 90% of the initial value after triggering is turned to the “off” state.

The basic operation of the metal-oxide semiconductor sensor is when the temperature of the sensor material increases, adsorption of oxygen molecules (O₂) on a surface of the sensor material attracts electrons and forms anionic species, such as O²⁻ and O⁻. An electron-depletion layer (EDL) for an n-type metal-oxide semiconductor sensor or a hole accumulation layer (HAL) for a p-type metal-oxide semiconductor sensor is formed at the surface of the sensor material. The interaction between the oxygen and the sensor material leads to an upward bending of the sensor material conduction band at the surface and forms a potential barrier. When the metal-oxide semiconductor sensor is exposed to a target gas, the target gas is adsorbed on the surface of the sensor material and reacts with ionic oxygen species by attracting electrons (oxidizing gases) or donating electrons (reducing gases). The transfer of the electrons between the target gas and sensor material regulates a width of EDL or HAL, resulting in a change in the overall resistance of the senor material. For example, for reducing gases, the electrons will transfer from the reducing gases to the n-type sensor, leading to a decrease in EDL and a decrease in resistance. In contrast, p-type sensing behavior is defined when a p-type sensor is exposed to the reducing gases, the HAL will shrink and the resistance will increase due to the donated electrons. Thus, the sensor response is opposite for oxidizing gases as opposed to the sensor response for reducing gases.

In many applications, however, the sensor material of metal-oxide semiconductor sensors have a small surface area to volume ratio for gas interaction with the sensor material. In addition, a metal-oxide semiconductor sensor with a sensor material having very little or no porosity has a low sensitivity capability of detecting the change in resistance of the sensor material.

Disclosed herein is a metal-oxide semiconductor sensor and a method of producing a sensor material (e.g., tin oxide (SnO₂)) that overcomes the aforementioned disadvantages. The method disclosed herein is a nanoparticle synthesis and calcination method that creates a large surface area to volume ratio of the sensor material. More specifically, the sensor material of the metal-oxide semiconductor sensor disclosed herein has a large surface area to volume ratio, so as to adsorb as much of the target gas as possible on the surface to provide a measurable detection, especially at low concentrations. In addition, the sensor material of the metal-oxide semiconductor sensor disclosed herein has a highly nanoporous structure (nanoporosity) where the nanoparticle synthesis process creates nanoparticles and nanopores, which contributes to the highly nanoporous structure.

Nanoporosity creates a high level of sensitivity of the metal-oxide semiconductor sensor to a target gas. Specifically, a surface of the sensor material is used as reaction points for the target gas to create the change in the resistance of the sensor material. A nanoporous structure (nanoporosity) creates a large surface area for the reaction. In other words, the surface area of the sensor material available for interaction with the target gas will be greater, which increases the sensitivity and reliability of the metal-oxide semiconductor sensor. Still further, the method of producing the sensor material can be modified to produce sensor materials having different nanoporosities thereby changing the surface area to volume ratio based on the type of target gas to be sensed. Thus, the method facilitates controlling the nanoporosity of the sensor material based on the application.

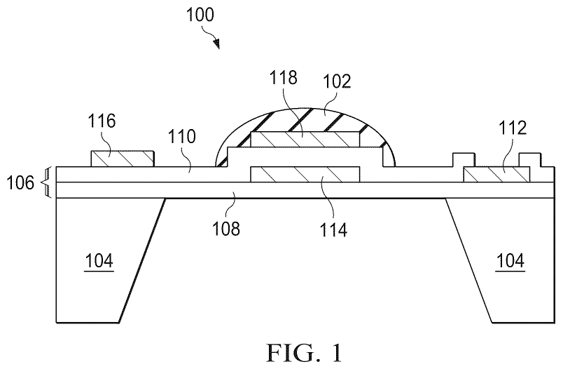

FIG. 1 is a cross-sectional view of an example metal-oxide semiconductor sensor 100 that includes a nanoporous structure sensor material (e.g., tin oxide (SnO₂)) 102 produced by a nanoparticle synthesis and calcination method resulting in a large surface area to volume ratio. The metal-oxide semiconductor sensor 100 is configured to detect a target gas (e.g., ethanol, carbon monoxide, hydrogen, ozone, etc.). The sensor 100 is comprised of supports (e.g., silicon supports) 104 and a substrate (e.g., silicon nitride membrane) 106 comprised of a first substrate (membrane) layer 108 and a second (membrane) substrate layer 110 disposed on the supports 104.

The sensor 100 further includes two electrical circuits to provide current to a heating element and to measure a change in resistance of the sensor material 102. Specifically, a first electrical circuit is comprised of a first contact 112 and a heating element (e.g., wire, resistor, coil, etc.) 114 both of which are disposed on the first substrate layer 108. A second electrical circuit is comprised of a second contact 116 and an electrode 118 both of which are disposed on the second substrate layer 110. The first electrical circuit provides a current through the sensor 100 to heat the sensor material 102 to a predetermined temperature. When the sensor 100 is exposed to a target gas, a resistance of the sensor material 102 changes as described above, which is detectable by the electrode 118 due to a change in current through the sensor material 102.

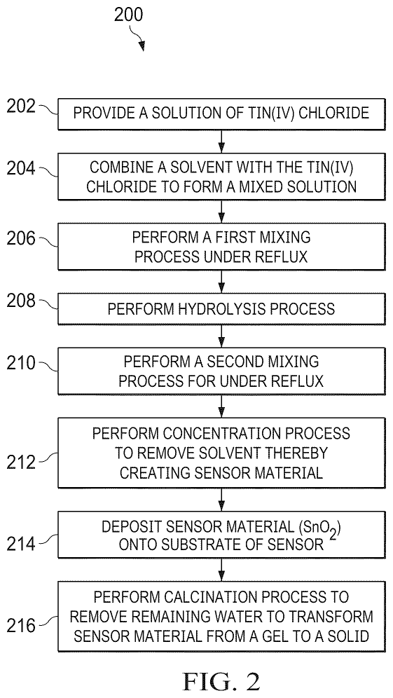

FIG. 2 is a block diagram flow chart explaining an example method 200 of producing the sensor material associated with the sensor 100 illustrated in FIG. 1. Though depicted sequentially as a matter of convenience, at least some of the actions shown can be performed in a different order and/or performed in parallel. Alternatively, some implementations may perform only some of the actions shown. Still further, although the example illustrated in FIG. 2 is an example method, other methods and configurations are possible. In addition, the volume of each solution used in the synthesis of the sensor material (e.g., SnO₂) described below can be modified to obtain a desired sensor material porosity based on the application of the metal-oxide semiconductor sensor. Finally, although the process described below describes the formation of tin oxide (SnO₂) as the sensor material, the process can be applied to other sensor materials. Thus, the process described below is for illustrative purposes only and is not intended limit the scope of the invention.

The process begins at 202 with a solution of tin(IV) chloride (e.g., 1 ml SnCl₄). For purposes of creating the desired reaction, the solution of SnCl₄ is contained in a solvent (e.g., heptane). At 204, a processing solvent (e.g., 2.5 ml isopropanol) is combined with the SnCl₄ to form a mixed solution. At 206, the mixed solution of SnCl₄ and the processing solvent undergoes a first mixing process for approximately 25-35 minutes at a first temperature range of approximately 85° C.-95° C. under reflux. Thus, during the first mixing process, since the processing solvent is chosen to have a boiling point less than the first temperature range, a reflux condenser is used to condense the evaporated processing solvent and return it to the mixed solution thereby preserving the processing solvent. At 208, a hydrolysis process is performed. Specifically, water (e.g., 1 ml H₂O) is added to the mixed solution to create the reaction illustrated by Eq. 1.

SnCl₄+4H₂O→Sn(OH)₄+4HCl Eq. 1.

During the hydrolysis process, the process solvent isolates the SnCl₄ from the heptane to allow the water to react with the SnCl₄. The water then breaks down the bond between the tin and the chloride in the SnCl₄ to allow the formation of the tin hydroxide Sn(OH)₄, which eventually leads to the formation of the sensor material (e.g., SnO₂).

At 210, after hydrolysis, a second mixing process is performed for approximately 55-65 minutes at a second temperature of approximately 85° C.-95° C. once again under reflux. Thus, during the second mixing process, since the processing solvent is chosen to have a boiling point less than the second temperature range, the reflux condenser once again condenses the evaporated processing solvent and returns it to the mixed solution thereby preserving the processing solvent. At 212, a concentration process is performed. The concentration process removes the processing solvent thus forming the tin oxide (SnO₂) and two units of water (2H₂O) illustrated by the reaction in Eq. 2.

Sn(OH)₄→SnO₂+2H₂O Eq. 2.

After the concentration process, the tin oxide (SnO₂) is in a gel form due to the presence of water.

At 214, the tin oxide (SnO₂) in gel form is deposited on a substrate of a metal-oxide semiconductor sensor similar to the sensor 100 illustrated in FIG. 1. At 216, the tin oxide (SnO₂), which is still is in gel form undergoes a calcination process to remove the remaining water from the gel tin oxide (SnO₂) thereby transforming the sensor material (SnO₂) from a gel to a solid. The calcination process is a process of heating a substance to remove moisture from the substance. The calcination temperature can range from 300° C.-450° C. based on the application of the metal-oxide semiconductor sensor. The removal of the water from the gel tin oxide (SnO₂) during calcination creates holes or pockets in the tin oxide (SnO₂) thereby forming a porous material. The porous material increases the surface area of the tin oxide, which increases the surface area to volume ratio of the sensor material, which in turn increases the sensitivity of the sensor material of the metal-oxide semiconductor sensor.

The process described herein can be modified or altered to control the nanoporosity of the sensor material based on the application of the metal-oxide semiconductor sensor. More specifically, the sensor material can be changed and/or the process can be modified to change the solvent and/or the quantity of the solutions used in the process can be modified and/or the mixing time and/or temperature during the first and second mixing times can be changed and/or the calcination temperature can be changed.

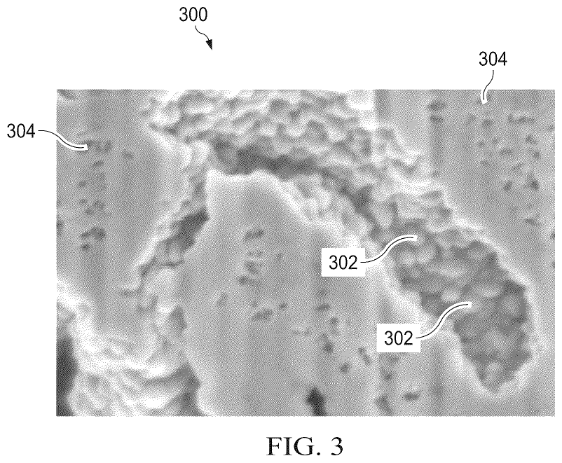

FIG. 3 is a microscopic view of a sensor material (e.g., SnO₂) 300 described herein. The microscopic view illustrates the nano structure (nanoporosity) of the sensor material 300 where nanoparticles 302 have a size ranging from approximately 10 nm-50 nm and nanopores 304 have a size ranging from approximately 10 nm-200 nm. Nanoporosity in a gas sensor material offers several significant benefits, including an increased surface area. One benefit of nanoporosity is that the nanoporous structure provides a larger surface area for gas molecules to interact with the sensing material. This increased surface area enhances the sensitivity of the sensor, allowing it to detect lower concentrations of gases. Thus, a large surface area of the sensor material is desirable to increase the sensitivity of the sensor material 300 and the sensor. Both large and small nanopores are desirable for quick response and measurement accuracy. Large nanopores provide fast gas diffusion and response. Small nanopores improve the signal-to-noise ratio due to the increase surface area, which provides more available sites for the target gas molecules to attach to the sensor material.

Nanoporosity also enhances gas adsorption. The presence of numerous large and small nano-sized pores allows for more gas molecules to be adsorbed onto the sensor material's surface. This improves the sensors ability to detect gases at very low concentrations, which is crucial for applications like environmental monitoring and industrial safety. Nanoporosity also improves gas diffusion. Specifically, porous structures facilitate better diffusion of gas molecules throughout the sensing material. This ensures that gas molecules can reach the active sites within the sensor more efficiently, leading to faster response times. Selectivity is still another benefit of a highly porous structure resulting from nanoporosity. The size and distribution of the nanopores can be engineered to selectively allow certain gas molecules to enter while excluding others. Selectivity is important for distinguishing between different gases in a mixture. Finally, an additional benefit of nanoporosity is stability and durability. Porous materials can be designed to maintain their structural integrity under various environmental conditions. This makes them suitable for long-term use in harsh environments. These benefits make nanoporous and micro-porous materials highly effective for gas sensing applications, enabling precise and reliable detection of various gases.

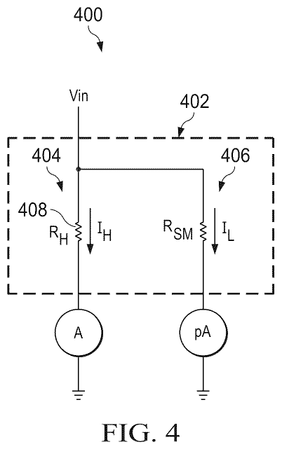

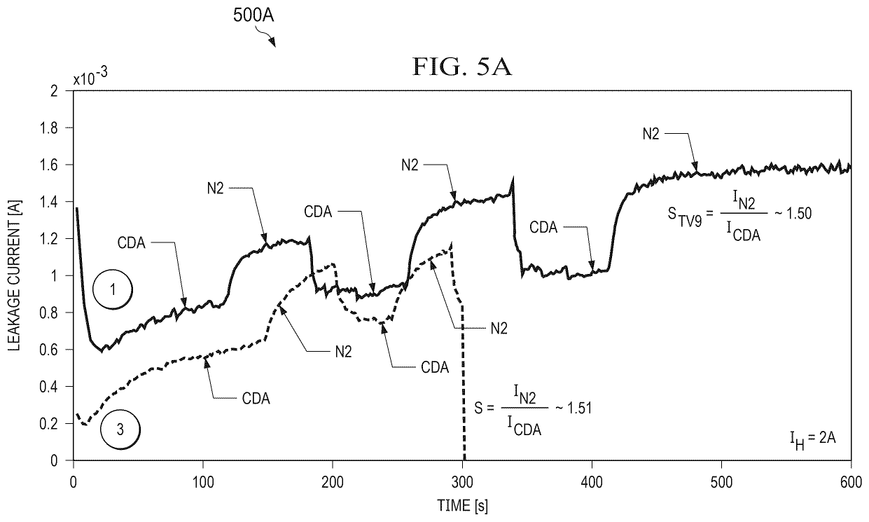

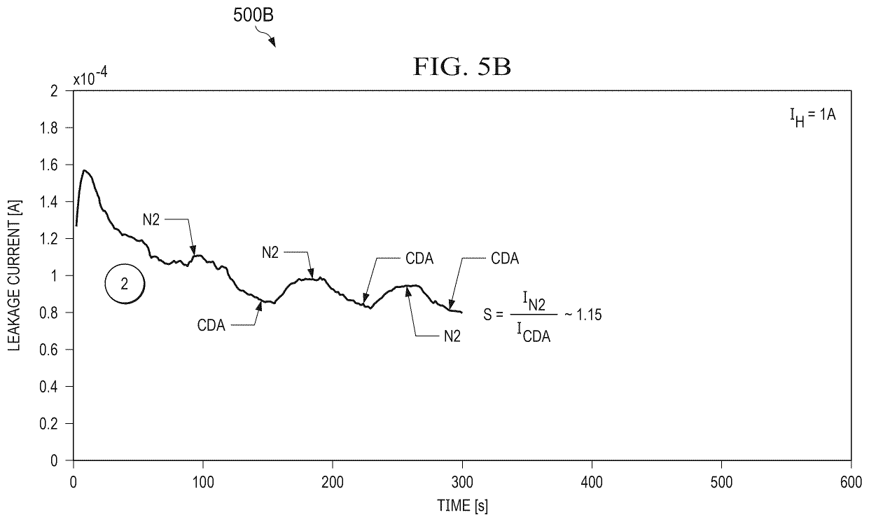

Referring to FIG. 4 and FIGS. 5A and 5B, FIG. 4 is a schematic of an example test sensor circuit 400 that simulates the operation of an example metal-oxide semiconductor sensor. The example test sensor circuit 400 includes the sensor material (SnO₂) 402 formulated by the process disclosed herein. FIGS. 5A and 5B are response curves that illustrate the response of the example test sensor circuit 400 in FIG. 4. The response curves 500A, 500B represent the sensitivity S of the sensor. The test sensor circuit 400 includes a first (heating) circuit 404 and a second (sensing) circuit 406. The first circuit 404 includes a heating element 408 that can be comprised of a wire, a resistor, coil, etc. The first circuit 404 further includes an ammeter A to measure a heating (first) current I_{H} through the heating element 408. The second circuit 406 includes a pico-ammeter pA that measures a leakage (second) current I_{L} through the sensor material 402.

During the test, the heater current I_{H} is kept at a constant value (e.g., 1 amps, 2 amps, etc.). A voltage drop on the heating element 408 and the leakage current IL through the sensor material are recorded during the test procedure. A resistance R_{SM} of the sensor material 402 is calculated by dividing the voltage across the sensor material 402 divided by the leakage current I_{L}. When the sensor encounters a target gas, the resistance of the sensor material changes thereby changing the current that flows through the sensor material. The change in current can be graphed as a response curve where a slope of the response curve is a measurement of sensitivity S. The slope of the response curve is a change in current through the sensor material from a time when no gas is detected to a time when the target gas is detected. A steeper slope indicates high sensitivity, while a moderate slope signifies a lower sensitivity. In the graphs in FIGS. 5A and 5B, the sensor is exposed to compressed dry air (CDA) and then to a gas. In this example the gas is nitrogen (N₂). The current through the sensor material when the sensor is exposed to the compressed dry air is denoted a I_{CDA} and the current through the sensor material when the sensor is exposed to the nitrogen gas is denoted as I_{N2}. Thus, the slope or sensitivity S of the graphs is defined as S=I_{N2}/I_{CDA}.

Referring to FIG. 5A, a first test FT1 was performed with a heater current I_{H} of 2 amps. As illustrated, the slope of the graph steeply or rapidly increases as the sensor is exposed to the compressed dry air and then the nitrogen gas resulting in a sensitivity value of approximately 1.50. Referring to FIG. 5B, a second test FT2 was performed where the heater current I_{H} was reduced to 1 amp. As illustrated the slope of the graph does not increase as steeply resulting in a sensitivity value of approximately only 1.15. This is because the heater current I_{H} did not provide the required heat to remove any type of substance on the sensor material to secure the sensor material to the sensor. Thus, the sensor material was unable to react with the nitrogen gas. Referring back to FIG. 5A, a third test FT3 was performed where the heater current I_{H} was increased back to 2 amps. Once again the slope of the graph increases steeply resulting in a sensitivity value of approximately 1.51.

Described above are examples of the subject disclosure. It is, of course, not possible to describe every conceivable combination of components or methodologies for purposes of describing the subject disclosure, but one of ordinary skill in the art may recognize that many further combinations and permutations of the subject disclosure are possible. Accordingly, the subject disclosure is intended to embrace all such alterations, modifications and variations that fall within the spirit and scope of the appended claims. In addition, where the disclosure or claims recite “a,” “an,” “a first,” or “another” element, or the equivalent thereof, it should be interpreted to include one or more than one such element, neither requiring nor excluding two or more such elements. Furthermore, to the extent that the term “includes” is used in either the detailed description or the claims, such term is intended to be inclusive in a manner similar to the term “comprising” as “comprising” is interpreted when employed as a transitional word in a claim. Finally, the term “based on” is interpreted to mean based at least in part.

What is claimed is:

1. A method comprising:
combining a solution of tin(IV) chloride with a processing solvent to form a mixed solution;
performing a first mixing process to the mixed solution for a first predetermined time period at a first predetermined temperature;
performing a hydrolysis process to add water to the mixed solution;
performing a second mixing process to the mixed solution for a second predetermined time period at a second predetermined temperature;
performing a concentration process to the mixed solution to remove the processing solvent; and
performing a calcination process to the mixed solution to remove the water from the mixed solution thereby converting the mixed solution from a gel to a solid.

2. The method of claim 1, wherein prior to performing a calcination process to the mixed solution to remove the water from the mixed solution thereby converting the mixed solution from a gel to a solid, the method further comprising depositing the mixed solution on a substrate of an electronic gas sensor.

3. The method of claim 2, wherein the electronic gas sensor is a metal-oxide semiconductor sensor.

4. The method of claim 1, wherein the processing solvent is isopropanol.

5. The method of claim 1, wherein the first predetermined time period is approximately 30 minutes and the first predetermined temperature is approximately 90° C.

6. The method of claim 1, wherein the second predetermined time period is approximately 60 minutes and the second predetermined temperature is approximately 90° C.

7. The method of claim 1, wherein the first mixing process and the second mixing process are performed under reflux.

8. The method of claim 1, wherein the calcination process includes heating the mixed solution to a temperature in a range of approximately 500° C. to 580° C.

9. The method of claim 8, wherein the calcination process creates holes and pockets in the solid mixed solution thereby forming a solid porous mixed solution.

10. The method of claim 9, wherein the solid porous mixed solution is tin oxide.

11. A gas sensor comprising:
a sensor material configured to detect a target gas, the sensor material having a nanoporous structure with pores in a range of approximately 10 nanometers to 200 nanometers;
a heating element configured to provide heat to the sensor material; and
an electrode configured to detect a change in resistance through the sensor material upon detection of the target gas.

12. The gas sensor of claim 11 further comprising a substrate disposed on supports, wherein the sensor material is disposed on the substrate.

13. The gas sensor of claim 12 further comprising a first electrical circuit including a first contact configured to be connected to a power source, the first electrical circuit configured to provide a first current to the heating element.

14. The gas sensor of claim 13 further comprising a second electrical circuit including a second contact connected to the electrode, the second electrical circuit configured to detect a change in a second current through the sensor material via the electrode.

15. The gas sensor of claim 14, wherein the sensor material is tin oxide.

16. A metal-oxide semiconductor gas sensor comprising:
a sensor material disposed on a substrate, the sensor material having a nanoporous structure with pores in a range of approximately 10 nanometers to 200 nanometers and being configured to detect a target gas;
a heating circuit configured to provide a first current through the sensor material to heat the sensor material; and
a sensing circuit configured to detect a second current through the sensor material.

17. The metal-oxide semiconductor gas sensor of claim 16, wherein the sensor material is tin oxide.

18. The metal-oxide semiconductor gas sensor of claim 16, wherein the heating circuit includes a first contact configured to be connected to an external power source and a heating element connected to the first contact.

19. The metal-oxide semiconductor gas sensor of claim 16, wherein the sensing circuit includes a second contact and an electrode, the electrode configured to detect the second current through the sensor material.

20. A metal-oxide semiconductor gas sensor having a tin oxide sensor material produced by the method of claim 1.
